(19) United States
(12) Patent Application Publication
(10) Pub. No.: US 2022/0396204 A1
(43) Pub. Date: Dec. 15, 2022

(54) VEHICLE HORN SOUND OUTPUT DEVICE

(71) Applicant: Woo Jin SIM, Seoul (KR)

(72) Inventor: Woo Jin SIM, Seoul (KR)

(21) Appl. No.: 17/771,815

(22) PCT Filed: Oct. 29, 2020
(86) PCT No.: PCT/KR2020/014952

§ 371 Date: Apr. 26, 2022

(30) Foreign Application Priority Data
Nov. 1, 2019 (KR) 10-2019-0138401

(51) Int. Cl. B60Q 5/00; B60K 35/00; G06F 3/0488; G06F 3/0482; G06F 3/16; G06F 3/04847; G10L 15/22; G10K 15/04

(52) U.S. Cl. CPC B60Q 5/001; B60K 35/00; B60Q 5/005; G06F 3/0488; G06F 3/0482; G06F 3/165; G06F 3/04847; G10L 15/22; G10K 15/04; B60K 2370/1434; G10L 2015/223

(57) ABSTRACT

A vehicle horn sound output device is disclosed. A vehicle horn sound output device according to the present invention comprises: an operation switch for outputting a horn sound; a storage unit for storing sound types to be output as horn sounds; a touch input unit for displaying a horn setting screen such that, by touching the horn setting screen, at least one from among the sound type, the volume, and the sound quality is set; and a control unit for executing an application so as to output a horn setting screen to the touch input unit, retrieving a sound type stored in the storage unit according to a setting value input from the touch input unit, setting the volume and the sound quality, and outputting a horn sound through a horn speaker if the operation switch is operated.

### TECHNICAL FIELD

The present invention relates to a vehicle horn sound output device, and more specifically, to a vehicle horn sound output device, which can set various sound effects and a sound volume of a vehicle horn by executing an application through a device such as an AVN provided in a vehicle or a mobile terminal, and can output sound volumes according to vehicle speeds and activate the vehicle horn even by voice commands or even in unexpected situations.

### BACKGROUND ART

In general, a horn for a vehicle is a sound device used to transmit sound in order to inform a surrounding alert or a dangerous situation during driving. The sound device is fixed to generate a fixed sound when a vehicle is shipped from a vehicle company, but it does not consider drivers' tastes or the other persons.

Therefore, when a horn is ringing during driving, an almost the same or similar warning sound is generated loudly so that it causes a large amount of stress beyond a degree of arousing a pedestrian's caution.

### DISCLOSURE

### Technical Problem

Recently, lots of young people use vehicles, such as cars or motorcycles, and the vehicles generate unique warning sounds through various selections.

However, there is a limitation in selecting sounds since a manufacturer stores various sounds of a vehicle horn in one chip in advance and selects a horn sound. So, it is difficult that a plurality of people select their own unique warning sounds and differently set a sound volume.

Accordingly, the present invention has been made in view of the above-mentioned problems occurring in the prior art, and it is an object of the present invention to provide a vehicle horn sound output device, which can set various sound effects and a sound volume of a vehicle horn by executing an application through a vehicle terminal or a mobile terminal, and can output sound volumes according to vehicle speeds and activate the vehicle horn even by voice commands or even in unexpected situations.

### Technical Solution

To accomplish the above object, there is provided a vehicle horn sound output device including: an operation switch outputting a horn sound; a storage unit storing sound types to output the horn sound; a touch input unit displaying a horn setting screen, and setting any one or more among a sound type, a sound volume, and a sound quality when a driver touches the horn setting screen; and a control unit executing an application so as to output the horn setting screen to the touch input unit, reading the sound type stored in the storage unit according to a setting value input from the touch input unit to set the sound volume and the sound quality, and outputting a horn sound through a horn speaker when the operation switch is operated.

The vehicle horn sound output device further includes a communication unit connecting the operation switch and the control unit by a wired/wireless communication method.

The vehicle horn sound output device further includes a mobile communication terminal synchronized with the control unit through the communication unit to transmit and upload the horn sound to the control unit through the application and to set one or more among the sound type, the sound volume, and the sound quality.

The vehicle horn sound output device further includes a vehicle speed sensing unit sensing a driving speed of the vehicle, wherein the control unit outputs the horn sound by differently setting the sound volume based on the driving speed input from the vehicle speed sensing unit.

The vehicle horn sound output device further includes a voice recognition unit recognizing a voice command of the driver, wherein the control unit outputs the horn sound when a voice command is recognized from the voice recognition unit.

The vehicle horn sound output device further includes an object sensing unit sensing an object in front of the vehicle, wherein the control unit outputs the horn sound when the object sensing unit senses the object within a set distance range from the object sensing unit 80 and within a set time or beyond a set speed.

### Advantageous Effects

The vehicle horn sound output device according to an aspect of the present invention can set various sound effects and a sound volume of a vehicle horn by executing an application through a vehicle terminal or a mobile terminal, and can output sound volumes according to vehicle speeds and activate the vehicle horn even by voice commands or even in unexpected situations, thereby securing safe driving, outputting various warning sounds suitable for a user's taste, and reducing stress applied to a pedestrian.

### BRIEF DESCRIPTION OF THE DRAWINGS

FIG. 1 is a block diagram illustrating a vehicle horn output device according to an embodiment of the present invention.

FIG. 2 is a view illustrating a horn setting screen of a mobile communication terminal by the vehicle horn output device according to the embodiment of the present invention.

FIG. 3 is a view illustrating a sound quality control screen of the mobile communication terminal by the vehicle horn output device according to the embodiment of the present invention.

FIG. 4 is a view illustrating a sound type selection screen of the mobile communication terminal by the vehicle horn output device according to the embodiment of the present invention.

FIG. 5 is a view illustrating a sound upload screen of the mobile communication terminal by the vehicle horn output device according to the embodiment of the present invention.

FIG. 6 is a view illustrating a volume setting screen of the mobile communication terminal by the vehicle horn output device according to the embodiment of the present invention.

FIG. 7 is a view illustrating a voice command operation screen of the mobile communication terminal by the vehicle horn output device according to the embodiment of the present invention.

### EXPLANATION OF REFERENCE NUMERALS

10: Operation switch 20: Mobile communication terminal
30: Communication unit 40: Storage unit
50: Touch input unit 60: Vehicle speed sensing unit
70: Voice recognition unit 80: Object sensing unit
90: Control unit 100: Horn speaker
110: Horn button

### MODE FOR INVENTION

Hereinafter, a vehicle horn sound output device according to the present invention will now be described in detail with reference to the attached drawings. In the drawings, thicknesses of lines and sizes of constituent elements may be exaggerated for clarity and convenience in explanation. In addition, the embodiment disclosed hereinafter does not limit the scope of the present invention, but corresponds to merely exemplary terms of constituent elements presented in claims of the present invention, and the embodiments that include replaceable constituent elements as equivalents of the constituent elements defined in the overall specification and claims may be included in the scope of the present invention.

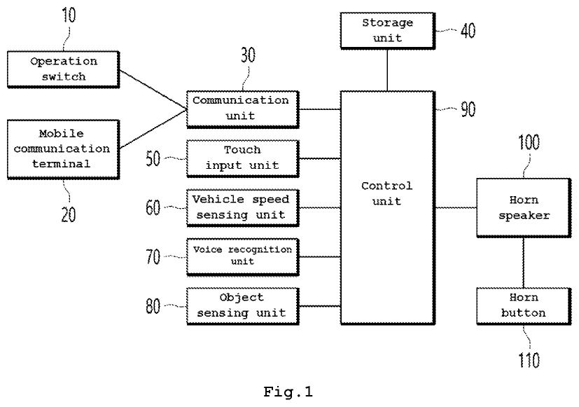

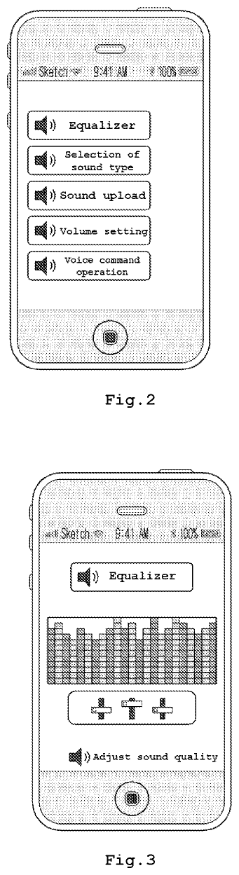

FIG. 1 is a block diagram illustrating a vehicle horn output device according to an embodiment of the present invention, FIG. 2 is a view illustrating a horn setting screen of a mobile communication terminal by the vehicle horn output device according to the embodiment of the present invention, and FIG. 3 is a view illustrating a sound quality control screen of the mobile communication terminal by the vehicle horn output device according to the embodiment of the present invention.

As illustrated in FIG. 1, the vehicle horn sound output device according to an embodiment of the present invention includes an operation switch 10, a storage unit 40, a touch input unit 50, a control unit 90, a communication unit 30, a mobile communication terminal 20, a vehicle speed sensing unit 60, a voice recognition unit 70, and an object sensing unit 80.

The operation switch 10 is a switch for outputting a horn sound according to the present embodiment, and can be accessorily installed together with a horn button 110 installed on a vehicle.

Here, when the horn button 110 is pressed, a sound of the horn basically mounted on the vehicle can be output through the horn speaker 100.

When the vehicle horn sound output device according to the present invention is not operated unexpectedly, the horn button 110 basically installed in the vehicle is operated to output the horn sound according to the present invention. Conversely, when the horn button 110 is not operated due to a failure, a driver can press the operation switch 10 to output the horn sound.

Moreover, the operation switch 10 can be connected by a wired communication method or a known wireless communication method such as Bluetooth, and can be installed at a position where a driver is convenient to operate.

A storage unit 40 can store sound types for outputting a horn sound.

Here, the sound types may be not only basically set sounds but also music, animal sounds, sounds of nature, and various sounds produced by a driver. The driver can upload and download and store such sounds.

The touch input unit 50 displays a horn setting screen, and can set one or more of a sound type, a sound volume, and a sound quality when the driver touches the horn setting screen.

The control unit 90 executes an application to output the horn setting screen to the touch input unit 50, reads the sound type stored in the storage unit 40 according to a setting value input from the touch input unit 50, and outputs a horn sound through the horn speaker 100 when the operation switch 10 is operated.

For example, as illustrated in FIG. 2, when an application is operated to set a horn sound of a vehicle, a menu capable of setting an equalizer, selection of a sound type, a sound upload, a volume setting, and a voice command operation for adjusting sound quality is provided to the horn setting screen.

When the driver touches the menu displayed on the horn setting screen, as illustrated in FIG. 3, the equalizer is adjusted to adjust sound quality, for instance, to reduce tone of a high-pitched sound according to a frequencies or to make a sonorous sound or a refreshing sound by raising a low-pitched sound.

The communication unit 30 can provide a communication interface so that the operation switch 10 and the control unit 90 are connected by a wired communication method or a wireless communication method such as Bluetooth.

Therefore, the operation switch 10 can be arranged at a convenient position that the driver wants.

The mobile communication terminal 20 is synchronized with the control unit 90 by the wired/wireless communication method, such as Bluetooth, through the communication unit 30 to transmit the horn sound to the control unit 90 through an application to upload the same, and can set any one or more among a sound type, a sound volume, and a sound quality.

Here, the mobile communication terminal 20 can download various horn sound sources through the wireless Internet, and transmit and upload the sound sources to the control unit 90. The driver can record the driver's voice through a sound source editing program to the recorded voice as a horn sound source, and can edit the existing sound source to the edited sound source as a horn sound source.

The vehicle speed sensing unit 60 can sense a driving vehicle speed of the vehicle based on a GPS algorithm, and provide the driving vehicle speed to the control unit 90.

Therefore, the control unit 90 can output the horn sound by differently setting the sound volume based on the driving vehicle speed input from the vehicle speed sensing unit 60.

For example, if the sound volume is set in the range from 5 dB to 80 dB in order to linearly correspond to the driving speed, the control unit 90 can output the horn sound with a volume ranging from 5 dB to 80 dB according to the driving vehicle speed.

Furthermore, if the sound volume is set for each section according to the driving vehicle speed, for example, if the sound volume is set to be in the range of 5 dB to 20 dB in a section ranging from 0 km to 30 km and in the range of 21 dB to 40 dB in a section ranging from 31 km to 60 km, the sound volume of the horn can be differently output according to the corresponding driving speed.

The voice recognition unit 70 recognizes a voice command of the driver and provides the recognized voice command to the control unit 90.

That is, the driver can output the horn sound with a voice command without touching the operation switch 10, and adjust the operation time of the horn according to the voice command.

Moreover, when the driver touches the operation switch 10 once, the horn sound is output for one second, and when the driver consecutively touches the operation switch 10 twice, the horn sound is output for two seconds. When the driver touches the operation switch 10 once during a continuous output without time limit, the output of the horn sound is stopped.

In this instance, the control unit 90 can output the horn sound set according to a voice command.

For example, when the driver says “Bang”, the horn sound may be output for one second, and when the driver consecutively says “Bang Bang”, the horn sound may be output for two seconds. Alternatively, when the driver says “Bang” during a continuous output without time limit, the output of the horn sound is stopped. So, the present invention is very useful for preventing an accident by giving notice to general persons, active children, disabled persons, or elderly persons, who may pop out of a narrow alley during driving, in advance.

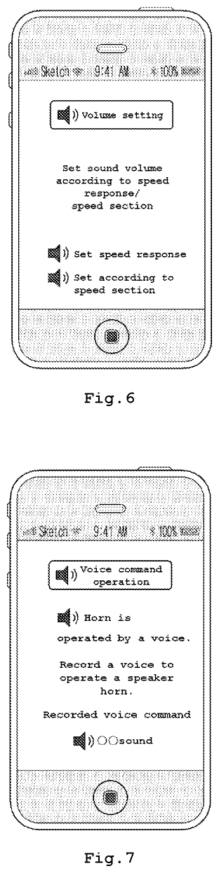

In this case, as illustrated in FIGS. 2 and 6, the sound automatically set is automatically emitted in a small sound during slow driving in a narrow alley so as to prevent pedestrians or the driver from feeling displeasure due to a loud horn sound.

The object sensing unit 80 senses an object in front of the vehicle and provides a sensing result to the control unit 90.

In this instance, the control unit can output the horn sound when the object sensing unit 80 suddenly senses an object within a set distance range from the object sensing unit 80 and within a set time or beyond a set speed, thereby enabling the driver to cope with a sudden situation even if the driver does not touch the operation switch 10 or does not give a voice command.

Next, various selection screens of the mobile communication terminal by the vehicle horn output device are illustrated.

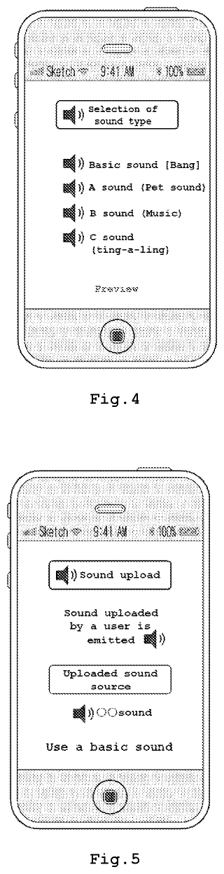

FIG. 4 is a view illustrating a sound type selection screen of the mobile communication terminal by the vehicle horn output device according to the embodiment of the present invention, FIG. 5 is a view illustrating a sound upload screen of the mobile communication terminal by the vehicle horn output device according to the embodiment of the present invention, FIG. 6 is a view illustrating a volume setting screen of the mobile communication terminal by the vehicle horn output device according to the embodiment of the present invention, FIG. 7 is a view illustrating a voice command operation screen of the mobile communication terminal by the vehicle horn output device according to the embodiment of the present invention.

For convenience of the user, guides for sound type selection, sound upload, sound volume and sound quality setting, voice command operation, setting of horn sound emitting method and emitting time, and setting of object sensing are all displayed on a screen.

As described above, The vehicle horn sound output device according to an aspect of the present invention can set various sound effects and a sound volume of a vehicle horn by executing an application through a vehicle terminal or a mobile terminal, and can output sound volumes according to vehicle speeds and activate the vehicle horn even by voice commands or even in unexpected situations, thereby securing safe driving, outputting various warning sounds suitable for a user's taste, and reducing stress applied to a pedestrian.

Meanwhile, the present invention can be implemented through electronic equipment of the vehicle. That is, the touch input unit 50 may be in the form of an AVN of the vehicle, and the storage unit 40, the control unit 90, the voice recognition unit 70, and the communication unit 30 may correspond to units constituting the AVN of the vehicle. The vehicle speed sensing unit 60 can sense the speed of the vehicle through an internal communication network of the vehicle, and the object sensing unit 80 may be a sensor provided in the vehicle, a camera, or a lidar.

In addition, the present invention may be implemented in the form of a mobile communication terminal. In this instance, the touch input unit 50 is a touch screen of the mobile communication terminal, and the storage unit 40, the control unit 90, the voice recognition unit 70, and the communication unit 30 can correspond to units constituting the mobile communication terminal. Additionally, the mobile communication terminal can draw the speed information of the vehicle through the internal communication network of the vehicle or recognize the current speed through a GPS, and can correspond to the vehicle speed sensing unit 60. Meanwhile, the object sensing unit 80 may be a sensor connected to the mobile communication terminal, a camera, or a lidar.

The embodiment described herein may be implemented, for example, as a method or a process, a device, a software program, a data stream or a signal. Although discussed only in the context of a single form of embodiment (e.g., only as a method), the embodiment of the discussed features may also be implemented in other forms (e.g., a device or program). The device may be implemented with appropriate hardware, software and firmware. The method may be implemented in an apparatus or a device, such as a processor, which generally refers to a processing device, such as, a computer, a microprocessor, an integrated circuit or a programmable logic device, or the like. The processor may be a communication device, such as a computer, a cell phone, a personal digital assistant (“PDA”), and the like that facilitate communication of information between end-users.

While the present disclosure have been described with reference to the embodiments illustrated in the drawings, the embodiments are just exemplary. It should be apparent that modifications and variations can be made by persons skilled without deviating from the spirit or scope of the invention.

Therefore, it is to be construed that the technical scope of the present invention should be defined by the appended claims and their equivalents.

What is claimed is:

1. A vehicle horn sound output device comprising:
an operation switch outputting a horn sound;
a storage unit storing sound types to output the horn sound;
a touch input unit displaying a horn setting screen, and setting any one or more among a sound type, a sound volume, and a sound quality when a driver touches the horn setting screen; and
a control unit executing an application so as to output the horn setting screen to the touch input unit, reading the sound type stored in the storage unit according to a setting value input from the touch input unit to set the sound volume and the sound quality, and outputting a horn sound through a horn speaker when the operation switch is operated.

2. The vehicle horn sound output device according to claim 1, further comprising a communication unit connecting the operation switch and the control unit by a wired/wireless communication method.

3. The vehicle horn sound output device according to claim 2, further comprising a mobile communication terminal synchronized with the control unit through the communication unit to transmit and upload the horn sound to the control unit through the application and to set one or more among the sound type, the sound volume, and the sound quality.

4. The vehicle horn sound output device according to claim 1, further comprising: a vehicle speed sensing unit sensing a driving speed of the vehicle,
wherein the control unit outputs the horn sound by differently setting the sound volume based on the driving speed input from the vehicle speed sensing unit.

5. The vehicle horn sound output device according to claim 1, further comprising a voice recognition unit recognizing a voice command of the driver,
wherein the control unit outputs the horn sound when a voice command is recognized from the voice recognition unit.

6. The vehicle horn sound output device according to claim 1, further comprising an object sensing unit sensing an object in front of the vehicle,
wherein the control unit outputs the horn sound when the object sensing unit senses the object within a set distance range from the object sensing unit 80 and within a set time or beyond a set speed.
